(19) United States
(12) Patent Application Publication
(10) Pub. No.: US 2008/0229232 A1
(43) Pub. Date: Sep. 18, 2008

(54) Full screen editing of visual media

(75) Inventors: Egan Schulz, San Jose, CA (US); Joshua D. Fagans, Redwood City, CA (US)

Correspondence Address: HICKMAN PALERMO TRUONG & BECKER LLP/Apple Inc., 2055 GATEWAY PLACE, SUITE 550, SAN JOSE, CA, 95110-1083, US

(73) Assignee: Apple Inc., CUPERTINO, CA (US)

(21) Appl. No.: 11/725,124

(22) Filed: Mar. 16, 2007

(51) Int. Cl. G06F 3/048

(52) U.S. Cl. 715/781

(57) ABSTRACT

Visual media can be edited by displaying a maximum amount of content on screen. To do so, a user can select a full-screen mode, which expands the visual media to fill the entire screen space. In full-screen mode, more of the screen is used to display the visual media as it is edited. In addition, the user can define bump areas in the visual media editing application, where the user can hide user interface controls while in full screen mode. From a user perspective these controls are sitting off screen and then brought into view as needed. The user accesses the user interface controls by bumping his mouse against the bump area, which causes the controls assigned to that region to come into view. In addition to defining bump areas, a user can decide which user interface controls to place at each different bump area.

### BACKGROUND

Over the last few years, visual media arts, such as photography and motion pictures, have become more sophisticated. In fact, applications that allow a user to create and edit images, film, and other visual content are becoming commonplace. For example, a photographer may use a digital camera to take a high-resolution photograph. High-resolution photographs may then be imported into a computer, and thereafter edited using photo-editing software executing on the computer.

Conventional visual media editing applications have user interfaces that include separate windows for different features available to users. For example, an image, imported from a digital camera to a computer for editing by an application executing on the computer, is typically displayed by the application in one window, while the controls to adjust the appearance of the image are displayed in another window. The available space displayed on the screen by the application must be large enough to accommodate both the image being edited and the controls for performing the editing. As the capabilities provided by visual media editing applications increase, the controls to perform these new functions occupy more and more area on the interface provided by these applications.

To further illustrate the problem with conventional visual media editing applications, consider how much space each element of the visual media editing application's user interfacetakes up on screen. The user interface for a visual media editing application typically includes a toolbar and menu options, which take up a portion of the screen space. The window in which the visual content being edited is displayed takes up another portion of the screen space. In addition, other windows containing editing tools and other features take up yet other portions of the screen space. In the end, a large portion of the screen space is used to display content other than the visual content being edited. Hence, even if the user expands the windows containing the visual media to fill the entire photo-editing application, a portion of the image is still obscured by the application's other user interface controls. As a result, when the user modifies the image, the user only sees the changes that occur to the visible portion of the image.

One way visual media editing applications have been improved to make more of the content visible is through the use of HUDs (heads-up displays). A HUD is a user interface control that is mostly transparent so that a user can see through it to the underlying content. The problem, however, with HUDs is that although they provide some degree of transparency, they can still be distracting and difficult to see through. In other words, they still take up screen space and can obscure portions of the visual media being displayed on screen.

Another way visual media editing applications have been enhanced to make more of the content visible while it is being edited is through the use of a toggle function. The toggle function allows a user to input a set of instructions that hide all of the application's user interface controls except for the window displaying the visual media. The problem with this approach is that when a visual media editing application is in toggle-mode, the visual media is not expanded beyond its normal display size. Thus, the user's view in toggle-mode is limited to the content's previous display size. Moreover, controls to edit the visual media are not provided in toggle mode. Thus, in order to edit the content the user has to toggle back into a normal editing mode.

As another example of a way visual media editing applications attempt to maximize screen usage, some applications implement auto-hiding menus along an edge of the screen (e.g., at the top, bottom, or a side of the applications' user interface). These auto-hiding menus appear when the user places his mouse (or cursor) at the edge of the user interface where the auto-hiding menus is located. The problem with these auto-hiding menus is that the options in the menus are not available in a full-screen mode. Moreover, the application provider chooses which menus can be auto-hidden and where those menus hide in the user interface. Thus, visual media editing applications that implement auto-hiding menus only hide one or two menus, either leaving all the other user interface controls on the screen (taking up screen space) or making the other user interface controls unavailable. In the end, auto-hiding menus do not make maximal use of the screen space. Finally, auto-hiding menus generally disappear as soon as the user moves his mouse away from the area where an auto-hiding menu is located.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIG. 1 is a depiction of an example user interface in a visual media editing tool, according to an embodiment of the invention;

FIG. 2 is a depiction of an example full screen user interface with bump areas, according to an embodiment of the invention;

FIG. 3 is a depiction of an example full screen user interface displaying additional controls in the bump areas, according to an embodiment of the invention;

FIG. 4 is a depiction of an example full screen user interface displaying a window from one bump area being moved to another area, according to an embodiment of the invention;

FIG. 5 is a flowchart illustrating an example procedure for editing visual media in a full-screen mode, according to an embodiment of the invention; and

FIG. 6 is a block diagram of a computer system upon which embodiments of the invention may be implemented.

### DETAILED DESCRIPTION

In the following description, for the purposes of explanation, numerous specific details are set forth in order to provide a thorough understanding of the embodiments of the invention discussed herein. It will be apparent, however, that the embodiments of the invention discussed herein may be practiced without these specific details. In other instances, well-known structures and devices are shown in block diagram form in order to avoid unnecessarily obscuring the embodiments of the invention discussed herein.

### Functional Overview

Mechanisms, as discussed herein, allow visual media to be edited in a mode that maximizes the amount of the visual media displayed on screen. Accordingly, the mechanisms allow a user to select a full-screen mode in a visual media editing application. In full-screen mode, visual media is expanded to fill the entire screen (or at least the portion of the screen taken up by the visual media editing application). In this way, all the visual media editing application's available screen space can be used to display the visual media as it is being edited.

Further mechanisms hide user interface controls in bump areas when the visual media editing application is in full-screen mode. A bump area is a location on screen (typically at the edges) where the user interface controls are hidden. The user accesses the user interface controls by placing their mouse in or against the bump area. Thus, from a user perspective these controls are sitting off screen and then brought into view as needed. For example, suppose a user is editing an image in a photo-editing tool. The user selects a “full screen” mode option that causes the photo-editing tool to expand to fill the screen. In this mode, photo-editing tools and other controls can be hidden from view in bump areas along the edge of the screen. To access those tools and controls, the user moves his mouse to a bump area at the edge of the screen, which then causes the tools and/or controls hidden at that bump area to come into view.

Additional mechanisms allow a user to assign user interface controls to bump areas.

### Full Screen Environment

The procedures and tools described in this invention are often described in terms of visual media editing technology and, more specifically, photo-editing technology. These environments are meant only to serve as exemplary environments in which the techniques of the present invention are employed. In alternative implementations, the techniques may be employed in other environments.

### Visual Media

Visual media includes content and data objects that are editable by a visual media editing application. As used herein, visual media is not limited to any particular structure or file format. For example, visual media can refer to an image in a photo-editing tool, a still image in a movie-editing application, a visual display of a sound file in a sound player, a Web page in a design application, elements of a CAD file, a 3D animated object, a movie file, and other types of data objects.

### Visual Media Editing User Interface

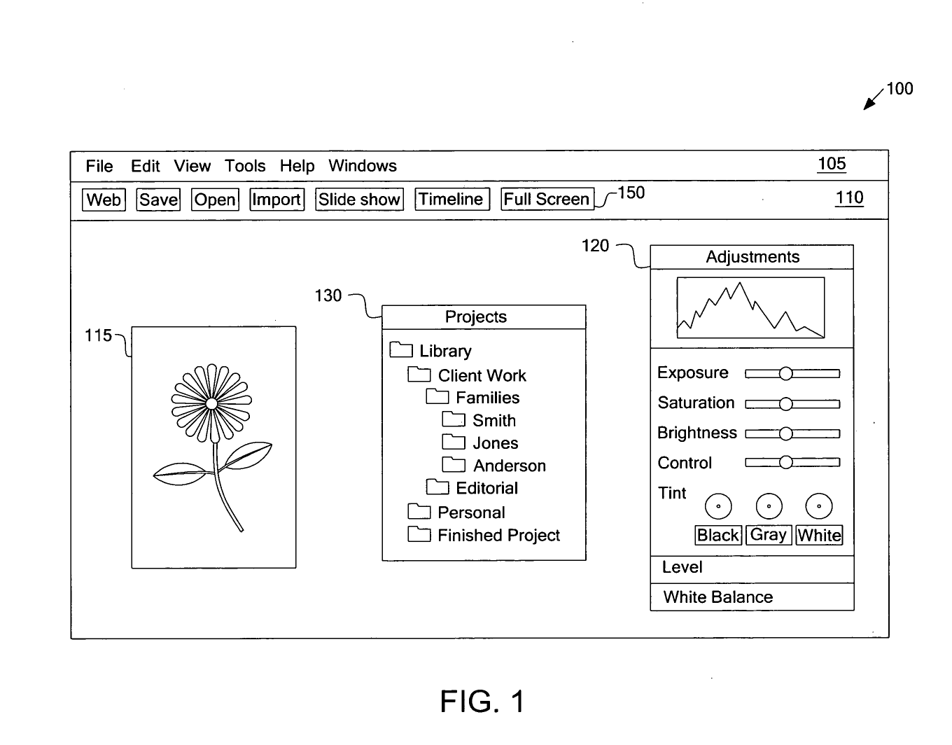

A visual media editing user interface generally refers to the portion of a visual media editing application with which a user interacts. Basically, the visual media editing user interface provides the user interface controls such as buttons, windows, menus, and toolbars that allow a user to edit visual media in a full-screen mode. An example visual media editing user interface is illustrated in FIG. 1.

FIG. 1 depicts example visual media editing user interface 100 that includes the following features: file menu 105, toolbar 110, editing window 115, project window 130, and adjustments window 120. In addition, visual media editing user interface 100 could include other controls, e.g., controls that allow the user to save, open, import, and perform other functions in a visual media editing context. User interface 100 also includes full screen control 150.

In another embodiment (not depicted), visual media editing user interface 100 includes a different set of features than those depicted in FIG. 1.

### Some Features of the User Interface

File menu 105 and toolbar 110 illustrate the types of user interface controls available in a visual media editing application. For example, file menu 105 includes menus such as file, edit, view, tools, help, and windows that when selected provide the user with additional options to help the user open, save, and edit visual media. The help menu can include a feature to search online documentation and access tutorials. The windows menu allows the user to switch between projects. The tools menu, when selected, displays additional tools that can be used to edit the displayed image. Similarly, toolbar 110 may include a buttons that when selected prompt the user to upload content to the web, save it, open a new file, import content into the application, make a slideshow, etc.

In one embodiment, editing window 115 refers to the portion of the user interface where visual media is displayed. As edits and adjustments are made to visual media, editing window 115 updates to show those changes.

Adjustments window 120 is a user interface control that includes other controls that allow the user to adjust parameters that affect the appearance of the visual media displayed in editing window 115. The controls displayed in adjustments window 120 when selected and adjusted cause the visual media to be modified according to the settings input into adjustments window 120. For example, suppose the visual media in editing window 115 is an image. Because it is an image, adjustments window 120 may include parameters, such as exposure, saturation, brightness, control, and tint, that allow the user to modify the image's appearance. When the user adjusts one of those parameters, the change in the parameter value is applied directly to the image in editing window 115.

An additional control in user interface 100 is projects window 130. Projects window 130 is an example of the other types of user interface controls that are in visual media editing user interface 100. As illustrated, projects windows 130 lists other visual media in the same project. For example, suppose a photographer takes pictures at weddings. All of the images from the same wedding may be stored as part of the same project. The manner in which the images are listed in projects window 130 varies. The images may be sorted according to who is in each picture, based on quality, etc. In one embodiment, projects window 130 may also list content from other projects. The features illustrated in FIG. 1 are examples of the types of features that may be available in a visual media editing user interface. In another embodiment, a different set of user interface controls may be used.

### Full-Screen Mode

Full-screen mode refers to the situation where the visual media being displayed on screen is expanded to fill the entire screen (or at least that portion of the screen taken up by the visual media editing user interface). By operating in the full-screen mode, a visual media editing user interface may display visual media using all the available screen space provided by the visual media editing user interface. By expanding the content into full-screen mode, the visual media becomes larger, which allows the user more fidelity in their work.

In one embodiment, full screen control 150 is the user interface control that, when selected, causes the visual media editing application to switch into full-screen mode. In FIG. 1, full screen control 150 is illustrated a button. In other implementations, full screen control 150 may be a different type of user interface control. When the user selects full screen control 150, the visual media in editing window 115 is expanded until it fills the entire screen.

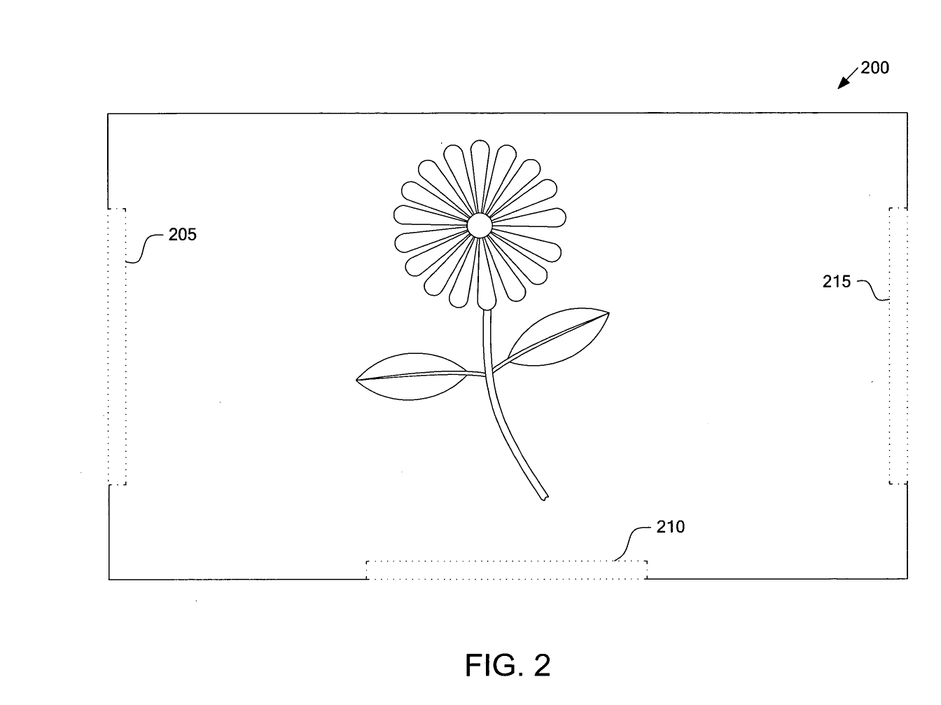

FIG. 2 illustrates example visual media user interface 200 that has been expanded to full-screen mode. In FIG. 2, all of the other user interface controls (e.g., projects window, adjustments window, toolbars, etc.) are hidden from immediate view and the visual media being edited is expanded to fill the entire screen.

Notice that in full-screen mode, the user can view the visual media in much greater detail. For example, suppose the user is editing an image in a photo-editing application. In a full-screen mode, the image is displayed on screen in as large an area as it can be displayed. As a result, none of the image is obscured by other user interface controls, which makes it easier to view and critique the image. A serious critique of the visual media can then be translated into very pointed edits and adjustments. In fact, in full-screen mode, the user can focus in on particular areas of the content that may not be viewable in a non-full-screen mode. Moreover, adjustments can be made to the visual media that may be difficult to make in a non-full-screen mode (e.g., editing a few pixels to enhance a particular feature of the visual media that normally would be obscured by other user interface controls.).

Once edits have been made in full-screen mode, the user sees how the edits affect the entire image, not just the unobscured parts of it. Hence, in full-screen mode, all (or at least most) of the visual media application user interface controls are hidden until accessed by the user.

To edit visual media in full-screen mode, the user may need to access some visual media editing user interface controls. In one embodiment, the user interface controls are overlayed on top of the visual media until the user has assigned the controls to bump areas (e.g., regions on the screen where the controls are hidden until accessed). Once the controls have been assigned to bump areas, in one embodiment, users can access those controls in full-screen mode to edit and manage visual media.

In one embodiment, bump areas are areas pre-defined on screen by the application designers. In addition, bump areas can be configurable by the user.

### Bump Areas

Bump areas refer to designated regions on screen (or even off screen at the edges of the visual media editing user interface) where user interface controls are hidden while the visual media editing user interface is in full-screen mode. Hiding in this context generally means that the user interface controls are not visible on screen, but may be accessed when the user hovers or bumps his mouse into a bump area on the screen. For example, in FIG. 2, bump areas 205, 210, and 215 are all designated regions on screen that cause user interface controls to be displayed when the user moves or bumps his mouse against those locations. In one embodiment, the bump areas are visible locations on screen (e.g., the boxes at the edge of a screen as shown in FIG. 2). Alternatively, the bump areas are located at the edges of the screen and therefore not visble to the eye. The user accesses the user interface controls at bump areas by bumping this mouse into the side of the screen.

FIG. 2 illustrates three bump areas 205, 210, and 215 located at the edges of the screen. One of the bump areas 210 is located at the bottom of the screen and the two other bump areas 205 and 215 are located on either side of the screen. In other implementations, a different number of bump areas could be used.

Even though, in FIG. 2, the bump areas are illustrated as being at the edges of the screen, bump areas do not need to be at the screen edges. Instead, they could be located elsewhere in the user interface, for example, in the center of the user interface, in the bottom right corner, upper left corner, or elsewhere.

According to one embodiment, a visual media editing application comes with certain bump areas predefined and pre-configured by the application designer. In various implementations, the location of at least some of the bump areas can also be determined by the user. For example, the visual media editing user interface can include user interface controls that prompt the user to enter the number of bump areas they would like to have in full-screen mode. Then, subsequent controls in the visual media editing user interface prompt the user to input where the bump areas should go on screen. This prompt may include a checklist of regions on screen (e.g., top, bottom, upper-right-hand corner, etc.), a template of predetermined locations, a series of prompts that allow the user to click and select specific locations to place the bump areas on screen, or some other means of designating bump areas.

Once bump areas have been designated, tools and controls can be assigned to those areas.

### Bump Controls

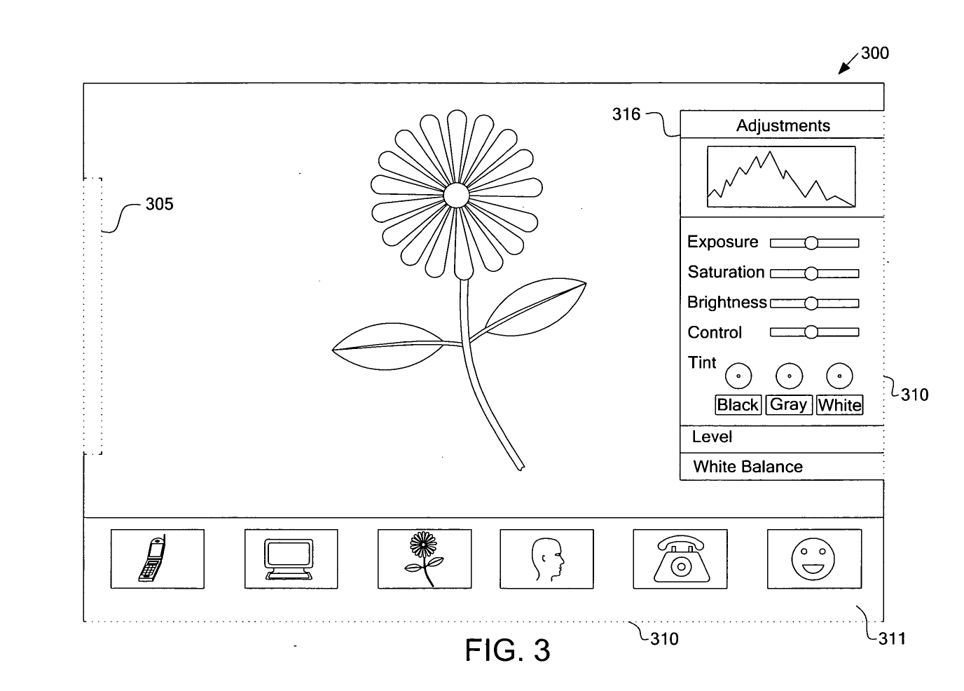

Bump controls generally refer to those user interface controls that are hidden at a bump area. Basically, bump controls can be any user interface control, such as toolbars, menu items, or windows, available to a visual media editing application in a non-full-screen mode. FIG. 3 illustrates a visual media editing user interface in full-screen mode with example bump controls 311 and 316 displayed on screen.

In FIG. 3, bump controls 311 and 316 have been assigned to bump areas 310 and 315 respectively. When the visual media editing user interface 300 is in full-screen mode, the user can move (or “bump”) his mouse pointer into bump area 310 to cause bump control 311 to appear.

In this example, bump control 311 is a user interface control that acts like a projector reel. It displays thumbnail images derived from other files associated with the current visual media editing project. For example, suppose the visual media shown in FIG. 3 is an image that the user has expanded to full-screen mode. The user edits the image and decides he would like to make similar edits to another image associated with this same project. Accordingly, the user “bumps his mouse into bump area 310” (in other words, moves his mouse pointer over or against bump area 310), causing projector reel bump control 311 to be displayed. The user then browses and navigates through the various thumbnail images displayed in the projector reel until he finds the other image he wants to edit. The user then selects that image by clicking his mouse on it while the mouse pointer is over the desired image. The second image is then opened. In one embodiment, the second image is opened into full-screen mode.

Note that in FIG. 3, when bump control 311 appears on screen, it can be animated by a variety of visual effects. By doing so, the user interface becomes more interactive and aesthetically pleasing. For example, in one embodiment, bump control 310 slides out of bump area 310 onto the screen. In another embodiment, bump control 311 may float onto screen or pop into view with sound effects. By moving through a series of intermediate locations, over time, before arriving at a final location, the user may easily ascertain, by looking at the screen, that bump control 311 is becoming available for use. Alternatively, bump control 311 may simply appear on the screen without any visual effects.

The other bump controls can also be animated to appear on screen with visual effects. For example, when the user bumps bump area 305 with his mouse a different bump control may appear using different visual effects.

As shown, bump control 316 corresponds to adjustments window 120 in FIG. 1. Bump control 316 includes controls and other mechanisms to edit the displayed visual media. In one embodiment, bump control 316 includes those core features that help the user to take advantage of the visual media editing application's capabilities. For example, in a photo-editing application, bump control 316 might include those items, such as a histogram of the image, brightness setting controls, tint setting controls, and contrast setting controls, that are used frequently by photographers to edit images. Similarly, in other visual media editing applications the bump controls can include those features that have been determined to be most useful to the application's users.

In one embodiment, the user can determine which controls he would like to assign to a bump area. To that end, the visual media editing user interface 300 may include controls (e.g., on a menu or toolbar) that allow the user to select and assign features and controls to defined bump areas. One way to assign a bump control to a bump area, according to one embodiment, is for the user to use his mouse to drag and drop menus, windows, toolbars, and other user interface controls to bump areas. Note that, in one embodiment, the user may do this in either full-screen mode or in a non-full screen mode.

For example, in a full-screen mode, suppose the user would like to assign adjustments window 120 in FIG. 1 to a bump area so that those particular controls are available for editing the visual media. Accordingly, the user drags and drops adjustments window 120 to the right-hand edge of the screen (e.g., a bump area), which causes the adjustments window to be assigned to that particular region on screen. Then, when the user wants to access the adjustments window, he merely bumps into the assigned region, e.g., by moving a mouse pointer over the assigned region. Bump control 316 at bump area 315 in FIG. 3 illustrates the result of the described assignment.

Now suppose that the user is in a non-full-screen mode. The user can assign a user interface control to a bump area in different ways. For example, a control may have a designated property that allows the user to assign it to a bump area. Similarly, in the non-full-screen mode, the user could define bump areas and drag and drop controls to the bump areas as described above.

In either mode, once a bump control has been assigned to a bump area, the user can move the bump control to different locations on screen. For example, the user can grab a bump control at one bump area and drag it to a different location on screen. In one embodiment, if the new location is not already a bump area, the visual media editing user interface automatically creates a new bump area at the new location.

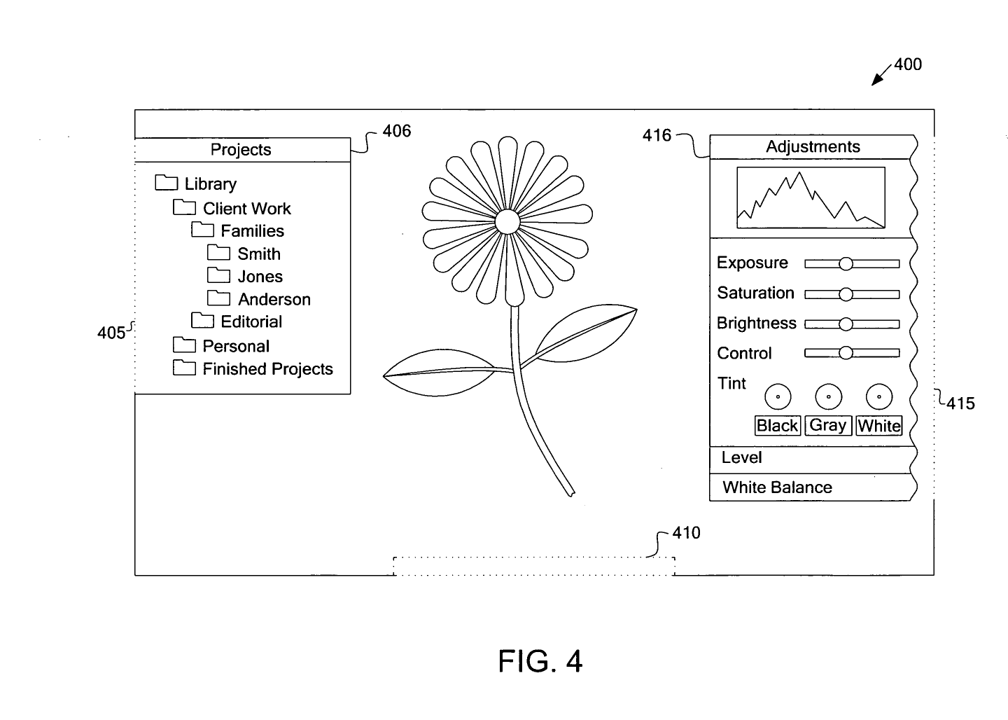

FIG. 4 illustrates the user interface 400 with a bump control “ripped” away from a bump area. In FIG. 4, bump control 416 is “ripped” from bump area 415 (e.g., the user selects the bump control using his mouse and drags the bump control away from the bump area 415). Ripping bump control 416 from bump area 415 causes bump control 416 to cease being associated with bump area 415. The user may use his mouse to drag and drop ripped bump control 416 to a different bump area (e.g., bump area 405 or 410), thereby causing bump control 416 to be associated with the new bump area corresponding to the new location of bump control 416. Similarly, bump control 406 and any bump control associated with bump area 410 could be ripped and moved to a different location on screen.

According to one embodiment, when bump control 416 is ripped from bump area 416, the bump control overlays the visual media until the user drops the bump control to a bump area. In this way, the bump control is not obscured by the visual media while the bump control is being repositioned. Once bump control 416 has been dragged to a bump area (e.g., back to bump area 415), it remains hidden until the user uses his mouse to bump into it again.

In one embodiment, ripping the bump control from a bump area while in full-screen mode indicates to the visual media editing user interface to remove that particular bump control from full-screen mode. In another embodiment, multiple bump controls can be assigned to a single bump area. In such an embodiment, the multiple bump controls may be displayed adjacent to one another or may appear in a combined fashion so as to appear as a single bump control.

Typically, after the user has bumped a bump area (i.e., caused a bump control associated with the bump area to be displayed), the bump control assigned to that area remains in view even after the user has moved his mouse away from the area. For example, in FIG. 4, after the user bumps bump area 415, the adjustments window bump control 416 remains in view until the user bumps bump area 415 again. Alternatively, bump control 416 hides after additional user input is received. For example, bump control 416 may be hidden after the user moves his mouse pointer away from the bump area 415 or the user clicks a button on the mouse when the mouse pointer is positioned over bump control 416.

Using these techniques, the user can customize the location of bump controls before editing visual media in a full-screen mode.

### Levels of Bump Controls

In one embodiment, the user can create global bump area assignments that carry over to other projects and/or visual media files. In other words, the bump controls and their assigned bump areas are common to every project and/or file in the application.

As the user creates new projects, the user can create bump control assignments that are project specific. These assignments can be saved as part of the project file (or as a template for files in the project) so that when a user works on other files and content in the same project the same tools and controls are available in full-screen mode.

In one embodiment, bump control assignments can also be made to bump areas that are file and/or content specific. For example, as shown in FIG. 3, the user may define the adjustments windows control 316 specifically for that particular piece of visual media. Accordingly, the bump areas and bump control assignments can be saved as part of the settings for that particular content. In one embodiment, those settings overwrite and replace any global or project scheme assignments. Basically, bump control to bump area assignments carry over from global or project schemes to individual files and content unless the user modifies those assignments for a particular piece of content. In this way, the user has control over which tools and controls are available at various stages of the editing in the application.

Note that although the user can customize the settings, in the end, the user can also default to the controls and tools provided by the application designers.

### Example Procedure for Editing Visual Media

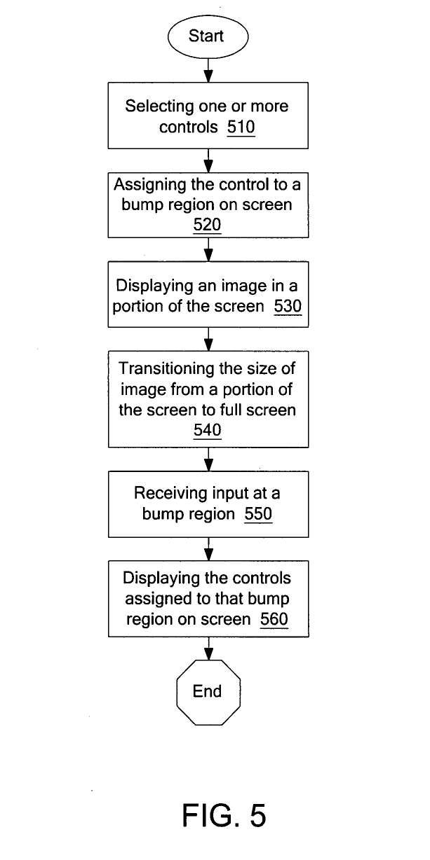

Turning to FIG. 5, it is a flowchart illustrating procedure 500 for accessing user interface controls while a visual media editing application is in full-screen mode. For example, in one embodiment, procedure 500 allows a user to edit an image in a photo-editing application.

It should be noted that although, procedure 500 is discussed below in terms of a photographer editing images using a photo-editing application, the principles described in connection with procedure 500 can be applied to a wide variety of other scenarios such as editing 3D graphics, editing Web pages and other visual media.

Assume for this example that a photographer named Bill has just recently returned from a vacation to the Amazon jungle in Brazil. While in the jungle, Bill took a large number of pictures of the jungle wildlife and plants. Among the images is a shot of a very rare flower. He now plans to edit the picture with the intent of putting it on display at an art gallery.

Accordingly, Bill opens a photo-editing application to edit the photo. The photo-editing application includes, among other things, a user interface that allows the user to display images, edit, and save images. In addition, the photo-editing application includes the necessary underlying logic to expand an image to a full-screen editing mode, to receive user input defining bump areas, to create bump areas, and to receive input assigning controls to those bump areas. According to one embodiment, displaying the images in the photo-editing application may include importing the images from a digital camera or other device.

The content and format of the images opened in the photo-editing application can vary from one project to another and from one implementation to another. For example, the photo-editing application should recognize multiple image file formats, such as JPG, GIF, TIF, RAW, BMP, etc.

In order to really be able to see and edit the image, Bill decides he would like to edit the image in full-screen mode. Accordingly, he configures the photo-editing application's user interface so that he can access his favorite editing tools and features in the application.

At step 510, Bill browses through the photo-editing application and determines which tools and controls are most useful to him when he edits images. For example, suppose Bill is editing an image in a photo-editing user interface corresponding to user interface 100 in FIG. 1. Bill typically uses the features and adjustment tools illustrated in adjustments window 120. So, he decides to assign adjustments window 120 to a bump area that can be accessed in full-screen mode. Accordingly, at step 520, Bill assigns adjustments window 120 to a bump area in the photo-editing application.

In one embodiment, Bill may have to first define where the bump areas are in the user interface. For example, in one embodiment, he selects options from the menu bar 105 or toolbar 110 that provide prompts to create bump areas on screen. Then, he selects other options from menu bar 105 or toolbar 110 that prompt him to assign controls to the new bump areas.

Alternatively, he simply drags and drops adjustments window 120 to the right-hand edge of user interface 100. In one embodiment, this tells user interface 100 to define a bump area on the right-hand edge of the user interface and to assign adjustments window 120 to that bump area.

As Bill creates bump areas and assigns controls to the bump areas, he can do this at a global level, meaning that he can define bump areas and controls that are accessible to every project in the photo-editing application. He can then save those settings as part of a global preference. Alternatively, he may want to customize which controls are assigned to what bump area based on the type of project or the specific image he is working on. Here, Bill plans on importing several images from his trip to Brazil into a single project. Since, he would like to have a consistent look from one image to the next, when he assigns adjustments window 120 to the right-hand edge of the screen, he saves the bump area and bump control assignments at a project level. By doing so, the same controls are available as he edits various images in the same project.

In one embodiment, Bill could also use a template with predefined bump areas and bump controls.

At step 530, Bill imports images of his vacation into the photo-editing application. Assume that Bill sorts through the images and selects the image of the flower to be edited. The image is opened and displayed in an editing window in the photo-editing application. In this example, the editing window in the photo-editing application corresponds to editing window 115 illustrated in FIG. 1.

After the image is opened in the photo-editing application, the image takes up only a small portion of the screen, while other user interface controls (e.g., projects window 130 and adjustments window 120) obscure much of the user interface. Accordingly, at step 540, Bill clicks on full screen button 150, which instructs the photo-editing application to transition from a normal editing mode into full-screen mode. This instruction causes the image in editing window 115 to expand to fill the screen. Moreover, all of the user interface controls that were previously on screen are removed from view. Only the image itself remains in view. FIG. 2 illustrates what the screen display of the photo-editing application can look like in full-screen mode.

In full-screen mode, Bill evaluates and critiques the image and determines that he needs to make a few adjustments to the image to make the flower really look more beautiful and ready for display in a gallery. Accordingly, Bill accesses the user interface controls that he previously assigned to bump areas. At step 550, he does so by “bumping” his mouse into a bump area (e.g., Bill bumps his mouse by positioning his mouse pointer over or against the bump area). For example, in FIG. 3, Bill bumps into bump area 315, which corresponds to the location where he placed the adjustments window, as described above.

At step 560, adjustments window 316 appears on screen in response to the bump at bump area 315. FIG. 3 shows what the on screen display looks like after the user bumps into a bump area in full-screen mode. Once adjustments window 316 is open, Bill can use his mouse to adjust the settings for the various parameters displayed. For example, Bill determines that the image is a little too dark, so he adjusts the brightness settings to make the image itself a little brighter.

As he makes the adjustments, in one embodiment, Bill moves his mouse away from the adjustments window 316. The result of this action is that adjustments window 316 slides back into bump area 315. In this way, the entire image can be viewed as the adjustments are applied to the image. This means that the portion of the image being obscured by adjustments window 316 as Bill makes the edits becomes unobscured when the adjustments are applied. This in turn means that Bill can see the total effect of his edits as they are applied to the image. Thus, if an edit negatively affects the portion of the image being obscured by adjustments window 316, Bill sees those effects immediately as adjustments window 316 slides back out of view.

In this case, after adjusting the brightness of the entire image, Bill notices that the change in brightness made the right-hand side of the image too light. Accordingly, Bill bumps his mouse against bump area 315 again, causing adjustments window 316 to reappear. He proceeds to make further adjustments to the image until he is satisfied with the finished product.

In one embodiment, adjustments window 316 remains on display even after Bill has moved his mouse away from the bump area and bump control. This may be because Bill wants to view the parameters shown in adjustments window 316 as he bumps his mouse against another bump area to access other controls.

In one embodiment, Bill can also rip and drag a bump control from one bump area to another. For example, in FIG. 4, Bill decides he does not like the location where adjustments window 416 is located. Accordingly, he grabs adjustments window 416 with his mouse and pulls it ways from bump area 415. Essentially, this rips the adjustments control from bump area 415. Once ripped from a bump area, Bill can drag adjustments window 416 to another bump area, or he can leave it on top of the image for easier access during the editing process.

In one embodiment, once he has completed editing the flower image, he can select another image to edit in full-screen mode. For example, in FIG. 3, he bumps his mouse against bump area 310, which causes a set of other images from the same project to be displayed (e.g., in bump control 311). Bill can then select to edit one of those images. Using the tools and techniques described herein, Bill can edit his photographs in a more meaningful way.

### Hardware Overview

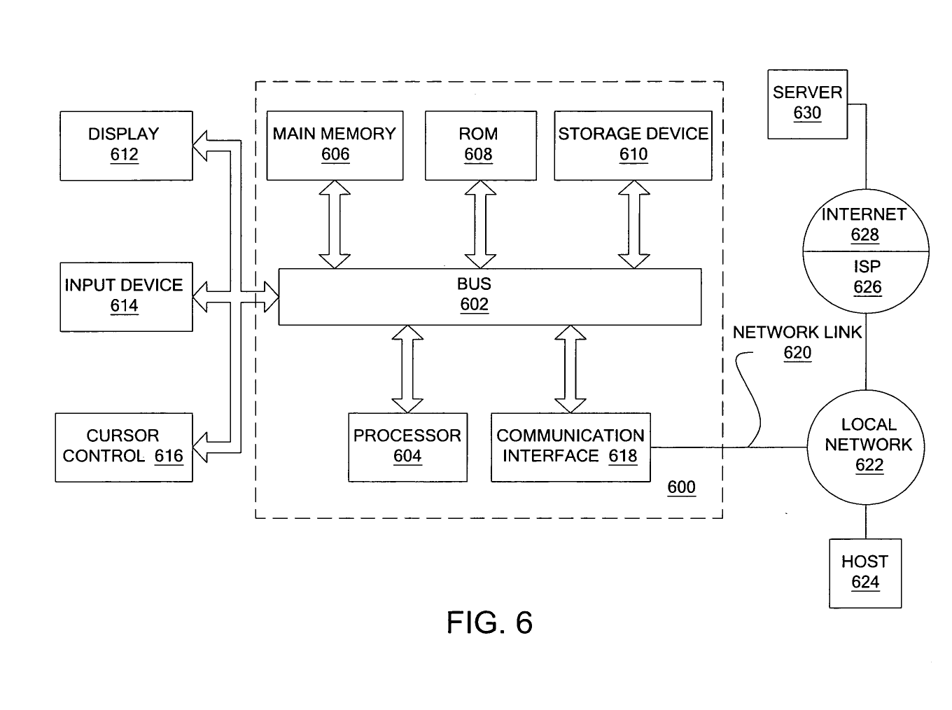

FIG. 6 is a block diagram that illustrates a computer system 600 upon which an embodiment of the invention may be implemented. Computer system 600 includes a bus 602 or other communication mechanism for communicating information, and a processor 604 coupled with bus 602 for processing information. Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Computer system 600 further includes a read only memory (ROM) 608 or other static storage device coupled to bus 602 for storing static information and instructions for processor 604. A storage device 610, such as a magnetic disk or optical disk, is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

The invention is related to the use of computer system 600 for implementing the techniques described herein. According to one implementation of the invention, those techniques are performed by computer system 600 in response to processor 604 executing one or more sequences of one or more instructions contained in main memory 606. Such instructions may be read into main memory 606 from another machine-readable medium, such as storage device 610. Execution of the sequences of instructions contained in main memory 606 causes processor 604 to perform the process steps described herein. In alternative implementations, hard-wired circuitry may be used in place of or in combination with software instructions to implement the invention. Thus, implementations of the invention are not limited to any specific combination of hardware circuitry and software.

The term “machine-readable medium” as used herein refers to any medium that participates in providing data that causes a machine to operation in a specific fashion. In an implementation implemented using computer system 600, various machine-readable media are involved, for example, in providing instructions to processor 604 for execution. Such a medium may take many forms, including but not limited to, non-volatile media, volatile media, and transmission media. Non-volatile media includes, for example, optical or magnetic disks, such as storage device 610. Volatile media includes dynamic memory, such as main memory 606. Transmission media includes coaxial cables, copper wire and fiber optics, including the wires that comprise bus 602. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 604 for execution. For example, the instructions may initially be carried on a magnetic disk of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are exemplary forms of carrier waves transporting the information.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution. In this manner, computer system 600 may obtain application code in the form of a carrier wave.

In the foregoing specification, implementations of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

1. A method comprising:
within an application, receiving first user input that selects one or more control sets from a plurality of available control sets;
wherein said application is assigned a particular screen space;
in response to said first user input, assigning each control set of said one or more control sets to a corresponding bump region within said particular screen space;
while in a first display mode, displaying, in said application, a data object to be edited in a first display region;
wherein said first display region includes less than all of said particular screen space;
receiving second user input;
in response to the second user input, transitioning the application from the first display mode to a second display mode;
while in the second display mode, the application displaying the data object to be edited in a second display region;
wherein the second display region includes all of said particular screen space;
while in the second display mode, receiving third user input within a bump region that corresponds to a particular control set of said one or more control sets; and
in response to said third user input, displaying said particular control set over a portion of said data object to be edited.

2. The method of claim 1, wherein assigning each control set of said one or more control sets to a corresponding bump region within said particular screen space further comprises receiving a fourth user input that defines a location in the particular screen space as a second bump region.

3. The method of claim 2, wherein said location is an edge of the screen space.

4. The method of claim 3, wherein said step of displaying said particular control set comprises displaying said particular control set at one or more intermediate locations before displaying said particular control set at a final location.

5. The method of claim 1, further comprising receiving fourth user input that requests said particular control set to cease being associated with the bump region that currently corresponds to said particular control set.

6. The method of claim 1, further comprising receiving fourth user input that requests said particular control set be moved to a new location on the particular screen space.

7. The method of claim 1, further comprising receiving fourth user input that requests said particular control set be moved to a new location on the particular screen space, wherein the application creates a new bump region at said new location.

8. The method of claim 1, further comprising receiving fourth user input that requests said particular control set be moved to a new location on the particular screen space, wherein the new location is an existing bump region.

9. The method of claim 1, wherein the particular control set is user-defined.

10. The method of claim 1, wherein said particular screen space corresponds to all available screen space of said particular screen space.

11. The method of claim 1, further comprising:
receiving fourth user input that requests that said particular control set be hidden;
in response to the fourth user input, ceasing to display said particular control set on said particular screen space.

12. An apparatus for editing visual media, comprising:
one or more processors; and
a machine-readable medium carrying instructions, wherein execution of the instructions by the one or more processors causes performance of a method, the method comprising:
within an application, receiving first user input that selects one or more control sets from a plurality of available control sets;
wherein said application is assigned a particular screen space;
in response to said first user input, assigning each control set of said one or more control sets to a corresponding bump region within said particular screen space;
while in a first display mode, displaying, in said application, a data object to be edited in a first display region;
wherein said first display region includes less than all of said particular screen space;
receiving second user input;
in response to the second user input, transitioning the application from the first display mode to a second display mode;
while in the second display mode, the application displaying the data object in a second display region;
wherein the second display region includes all of said particular screen space;
while in the second display mode, receiving third user input within a bump region that corresponds to a particular control set of said one or more control sets; and
in response to said third user input, displaying said particular control set over a portion of said data object.

13. The apparatus of claim 12, wherein said instructions for assigning each control set of said one or more control sets to a corresponding bump region within said particular screen space further comprises instructions for receiving a fourth user input that defines a location in the particular screen space as a second bump region.

14. The apparatus of claim 13, wherein said location is an edge of the screen space.

15. The apparatus of claim 14, wherein displaying said particular control set comprises displaying said particular control set at one or more intermediate locations before displaying said particular control set at a final location.

16. The apparatus of claim 12, further comprising instructions for receiving fourth user input that requests said particular control set to cease being associated with the bump region that currently corresponds to said particular control set.

17. The apparatus of claim 12, further comprising instructions for receiving fourth user input that requests said particular control set to be moved to a new location on the particular screen space.

18. The apparatus of claim 12, further comprising:
instructions for receiving fourth user input that requests said particular control set to be moved to a new location on the particular screen space; and
instructions for creating a new bump region at said new location.

19. The apparatus of claim 12, further comprising:
instructions for receiving fourth user input that requests said particular control set to be moved to a new location on the particular screen space, wherein the new location is an existing bump region.

20. The apparatus of claim 12, wherein the particular control set is user-defined.

21. The apparatus of claim 12, wherein said particular screen space corresponds to all available screen space of said particular screen space.

22. The apparatus of claim 12, further comprising:
instructions for receiving fourth user input that requests that said particular control set be hidden;
instructions for ceasing to display said particular control set on said particular screen space in response to the fourth user input.

23. A machine-readable storage medium storing instructions for editing visual media, wherein execution of the instructions by one or more processors performs a method, said method comprising:
within an application, receiving first user input that selects one or more control sets from a plurality of available control sets;
wherein said application is assigned a particular screen space;
in response to said first user input, assigning each control set of said one or more control sets to a corresponding bump region within said particular screen space;
while in a first display mode, displaying, in said application, a data object to be edited in a first display region;
wherein said first display region includes less than all of said particular screen space;
receiving second user input;
in response to the second user input, transitioning the application from the first display mode to a second display mode;
while in the second display mode, the application displaying the data object in a second display region;
wherein the second display region includes all of said particular screen space;
while in the second display mode, receiving third user input within a bump region that corresponds to a particular control set of said one or more control sets; and
in response to said third user input, displaying said particular control set over a portion of said data object.

24. The machine-readable storage medium of claim 23, wherein said instructions for assigning each control set of said one or more control sets to a corresponding bump region within said particular screen space further comprises instructions for receiving a fourth user input that defines a location in the particular screen space as a second bump region.

25. The machine-readable medium storage of claim 24, wherein said location is an edge of the screen space.

26. The machine-readable storage medium of claim 25, wherein displaying said particular control set comprises displaying said particular control set at one or more intermediate locations before displaying said particular control set at a final location.

27. The machine-readable storage medium of claim 23, further comprising instructions for receiving fourth user input that requests said particular control set to cease being associated with the bump region that currently corresponds to said particular control set.

28. The machine-readable storage medium of claim 23, further comprising instructions for receiving fourth user input that requests said particular control set be moved to a new location on the particular screen space.

29. The machine-readable storage medium of claim 23, further comprising:
instructions for receiving fourth user input that requests said particular control set be moved to a new location on the particular screen space; and
instructions for creating a new bump region at said new location.

30. The machine-readable storage medium of claim 23, further comprising instructions for receiving fourth user input that requests said particular control set be moved to a new location on the particular screen space, wherein the new location is an existing bump region.

31. The machine-readable storage medium of claim 23, wherein the particular control set is user-defined.

32. The machine-readable storage medium of claim 23, wherein said particular screen space corresponds to all available screen space of said particular screen space.

33. The machine-readable storage medium of claim 23, further comprising:
instructions for receiving fourth user input that requests that said particular control set be hidden; and
instructions for ceasing to display said particular control set on said particular screen space in response to the fourth user input.

34. A method of editing an image, the method comprising:
assigning a visual media editing application a particular screen space;
in response to user input, assigning a particular portion of the periphery of the particular screen space to be a bump region;
while in a first display mode, displaying, in the visual media editing application, the image in a first display region;
wherein said first display region includes less than all of said particular screen space;
receiving first user input;
in response to the first user input, transitioning the visual media editing application from the first display mode to a second display mode;
while in the second display mode, the visual media editing application displaying the image in a second display region;
wherein the second display region includes all of said particular screen space;
while in the second display mode, automatically displaying one or more control sets in response to user input at a bump region.

35. The method of claim 34, further comprising:
while in the second display mode, receiving second user input at a bump region;
wherein said bump region corresponds to a particular location in said particular screen space;
in response to said second user input, displaying a control set assigned to said bump region over a portion of said image.

36. The method of claim 34, further comprising:
within the visual media editing application, receiving second user input that selects a control set from a plurality of available control sets; and
in response to said second user input, assigning said control set to a corresponding bump region within said particular screen space.
